(19) United States
(12) Patent Application Publication
(10) Pub. No.: US 2025/0035472 A1
(43) Pub. Date: Jan. 30, 2025

(54) METHOD FOR OPERATING A MAGNETIC-INDUCTIVE FLOWMETER

(71) Applicant: Endress+Hauser Flowtec AG, Reinach (CH)

(72) Inventors: Florent Tschambser, Hesingue (FR); Tulio Paiva Galvao, Schopfheim (DE); Werner Wohlgemuth, Seewen (CH); Pierre-Jean Ober, Hagenthal-le-bas (FR)

(21) Appl. No.: 18/715,566

(22) PCT Filed: Nov. 28, 2022
(86) PCT No.: PCT/EP2022/083504

§ 371 Date: May 31, 2024

(30) Foreign Application Priority Data
Dec. 1, 2021 (DE) 10 2021 131 696.0

(51) Int. Cl. G01F 1/60; G01F 1/58

(52) U.S. Cl. CPC G01F 1/60; G01F 1/588

(57) ABSTRACT

A method for operating a magnetic-inductive flowmeter includes: applying a first voltage signal to a device for generating a magnetic field, the first voltage signal being divided into time intervals, each having a first time sub-interval, in which a first voltage is applied to the device, wherein the first voltage is controlled such that a deviation of the coil current from a predetermined coil current target value during a measurement interval is minimized, wherein the coil current target value is constant for the entire first voltage signal; and applying a second voltage signal to the device, the second voltage signal being divided into time intervals, each having a second time sub-interval, in which a second voltage is applied to the device, wherein the second voltage is controlled such that a deviation of a control function from a control target value is minimized.

The invention relates to a method for operating a magnetic-inductive flowmeter.

Magnetic-inductive flowmeters are used for determining the flow rate and the volumetric flow of a flowing medium in a pipeline. A distinction is made here between in-line magnetic-inductive flowmeters and magnetic-inductive flow measuring probes, which are inserted into a lateral opening of a pipeline. A magnetic-inductive flowmeter has a device for generating a magnetic field, which produces a magnetic field perpendicularly to the flow direction of the flowing medium. Single coils are typically used for this purpose. In order to realize a predominantly homogeneous magnetic field, pole shoes are additionally formed and attached such that the magnetic field lines run over the entire tube cross section substantially perpendicularly to the transverse axis or in parallel to the vertical axis of the measuring tube. In addition, a magnetic-inductive flowmeter has a measuring tube on which the device for generating the magnetic field is arranged. A measurement electrode pair attached to the lateral surface of the measuring tube taps an electrical measurement voltage or potential difference which is applied perpendicularly to the direction of flow and to the magnetic field and occurs when a conductive medium flows in the direction of flow when the magnetic field is applied. Since, according to Faraday's law of induction, the tapped measurement voltage depends on the velocity of the flowing medium, the flow rate and, with the inclusion of a known tube cross section, the volumetric flow can be determined from the induced measurement voltage.

In contrast to a magnetic-inductive flowmeter, which comprises a measuring tube for conducting the medium with an attached device for generating a magnetic field penetrating the measuring tube and with measuring electrodes, magnetic-inductive flow measuring probes are inserted with their usually circular cylindrical housings into a lateral opening of a pipeline and fixed in a fluid-tight manner. A special measuring tube is no longer necessary. The measuring electrode arrangement and coil arrangement, mentioned in the introduction, on the lateral surface of the measuring tube are omitted and are replaced by a device for generating a magnetic field, which device is arranged in the interior of the housing and in direct proximity to the measuring electrodes and is designed such that an axis of symmetry of the magnetic field lines of the generated magnetic field perpendicularly intersects the front face or the face between the measuring electrodes. In the prior art, there is already a plurality of different magnetic-inductive flow measuring probes.

Magnetic-inductive flowmeters are often used in process and automation engineering for fluids, starting from an electrical conductivity of approximately 5 μS/cm. Corresponding flowmeters are sold by the applicant in a wide variety of embodiments for various fields of application, for example under the name PROMAG or MAGPHANT.

There is a plurality of different methods for controlling the operating signal applied to the coil arrangement. Generally, they aim at generating a magnetic field with a magnetic induction that is as constant as possible over an entire measurement phase. WO 2014/001026 A1, for example, discloses a controller in which a voltage signal applied to the coil arrangement is controlled in such a way that a coil current flowing through the coil arrangement reaches and maintains a coil current setpoint value in a defined measurement phase. The coil current flowing through the coil arrangement produces a magnetic field with a magnetic induction that depends on the coil current.

DE 10 2015 116 771 B4 also discloses a method for setting a constant magnetic field strength of a magnetic field in a magnetic-inductive flowmeter. In this case, a constant setpoint current is specified for a current controller.

It is basically assumed that by establishing a fixed coil current setpoint value for all time intervals, the magnetic induction of the produced magnetic field also assumes a setpoint value in a reproducible manner. An advantage of such a control is that the control does not require measuring the magnetic induction. However, it has been found that, due to temperature changes and magnetic interference fields, the magnetic field cannot be reproduced solely by adjustment to a fixed coil current setpoint value. As a result, the calibration values assumed for determining the flow-rate-dependent measured variable for magnetic induction differs from the currently present magnetic induction in the measuring tube. Depending on the disturbance variable, this can lead to deviations of up to 20% when determining the flow-rate-dependent measured variable.

The object of the invention is to provide a solution.

The object is achieved by the method according to claim 1 and the magnetic-inductive flowmeter according to claim 17.

The method according to the invention for operating a magnetic-inductive flowmeter for determining a flow-rate-dependent measured variable of a flowable medium, wherein the magnetic-inductive flowmeter comprises a device for generating a magnetic field and a device for tapping off a measurement voltage in the medium, comprising the method steps of:
applying a first voltage signal to the device for generating the magnetic field,
   wherein the first voltage signal has a voltage curve which is variable over time and which is divided into time intervals t,
   wherein the time intervals t each have a first time subinterval t_{hold,1}, in which a first voltage U_{hold,1}, which is in particular constant over the, in particular entire, first time subinterval t_{hold,1}, is applied to the device for generating the magnetic field,
   wherein the time intervals t each have at least one measurement interval tₘₑₐₛ in which a coil current flows through the device for generating the magnetic field,
   wherein the first voltage U_{hold,1} is controlled in such a way that a difference between the coil current and a coil current setpoint value, in particular a factory-predetermined coil current setpoint value, during the measurement interval tₘₑₐₛ is minimal,
   wherein the coil current setpoint value is constant for the entire first voltage signal,
applying a second voltage signal to the device for generating the magnetic field,
   wherein the second voltage signal also has a voltage curve which is variable over time and which is divided into time intervals t,
   wherein the time intervals t each have a second time subinterval t_{hold,2}, in which a second voltage U_{hold,2}, which is in particular constant over the, in particular entire, second time subinterval t_{hold,2}, is applied to the device for generating the magnetic field,
   wherein the second voltage U_{hold,2} is controlled in such a way that a difference between a control function and a control setpoint value, in particular comprising a variable proportional to the magnetic flux, is minimal.

The flowmeter according to the invention for determining a flow-rate-dependent measured variable of a flowable medium is characterized in that an operating circuit is configured to carry out the method according to the invention.

By providing two differently controlled voltage signals, it is possible to compare or check the individual setpoint values to be controlled. The setpoint value of the second voltage signal to be controlled can be determined using the first voltage signal or the setpoint value of the first voltage signal can be checked or a corrected setpoint value can be determined using the second voltage signal.

Advantageous embodiment of the invention are the subject matter of the dependent claims.

One embodiment provides the following method step:
determining the control setpoint value as a function of a regulated voltage value of the first voltage (U_{hold,1}).

Controlling the first voltage signal, in particular the first voltage U_{hold,1}, in such a way that a predetermined coil setpoint value is reached in a measurement interval has the advantage that the control setpoint value of the second voltage signal can thus be determined without having to carry out an external adjustment. The first voltage U_{hold} resulting from the control can be used to determine the control setpoint value. By switching the first voltage signal to a second voltage signal, in which there is no control to a predetermined coil current, but to the previously determined control setpoint value, it is possible to switch to a more robust control with respect to external magnetic fields.

One embodiment provides that the time intervals t of the first voltage signal each have a third time subinterval t_{shot,1}, in which a third voltage U_{shot,1}, which is in particular constant over the, in particular entire, third time subinterval t_{shot,1}, is applied to the device for generating the magnetic field,
wherein the third voltage U_{shot,1} is greater than the first voltage U_{hold,1},
where the duration of the third time subinterval t_{shot,1} is a controllable variable,
wherein a regulated duration of the third time subinterval t_{shot,1} is included in the determination of the control setpoint value.

One embodiment provides that the time intervals t of the second coil signal each have a fourth time subinterval t_{shot,2}, in which a fourth voltage U_{shot,2}, which is in particular constant over the, in particular entire, fourth time subinterval t_{shot,2}, is applied to the device for generating the magnetic field,
wherein the fourth voltage U_{shot,2} is greater than the second voltage U_{hold,2},
wherein the control function depends on a product of the duration of the fourth time subinterval t_{shot,2} and a function dependent on the second voltage U_{hold,2}.

In one embodiment, a quotient of the second voltage U_{hold,2} and the fourth voltage U_{shot,2} is constant over the voltage curve,
wherein the function dependent on the second voltage U_{hold,2} is inversely proportional to the duration of the fourth time subinterval t_{shot,2}.

In one embodiment, a value of the fourth voltage U_{shot,2} is constant over the time intervals t.

In one embodiment, an amount of a quotient of the first voltage U_{hold,1} and the third voltage U_{shot,1} is constant over the voltage curve.

In one embodiment, the value of the third voltage U_{shot,1} is constant over the time intervals t.

In one embodiment, the coil current in each case assumes a maximum coil current value Iₘₐₓ in the time intervals t of the second voltage signal, in particular in the second time subinterval t_{hold,2},
wherein the condition is fulfilled that one of a quotient of the maximum coil current value Iₘₐₓ and a coil current value I_{hold} determined during the second time subinterval t_{hold,2}, in particular during the measurement interval, is constant over the second voltage signal.

In one embodiment, the coil current in each case assumes a maximum coil current value Iₘₐₓ in the time intervals t of the second voltage signal, in particular in the second time subinterval t_{hold,2},
wherein the function dependent on the second voltage U_{hold,2} also depends on the maximum coil current value Iₘₐₓ.

In one embodiment, the function dependent on the second voltage (U_{hold,1}) also depends on ln((U_{shot,2}+U_{hold,2})/(U_{shot,2}−U_{hold,2})), in particular is proportional thereto.

In one embodiment, the control setpoint value is also determined as a function of the third voltage U_{shot,1}.

In one embodiment, the coil current in each case assumes a maximum coil current value Iₘₐₓ in the time intervals t of the second voltage signal, in particular in the second time subinterval t_{hold,2},
wherein the control setpoint value is also determined as a function of the maximum coil current value Iₘₐₓ and/or a coil current value I_{hold} determined during the measurement interval of the second voltage signal.

In one embodiment, the control setpoint value is determined as a function of an apparent inductance or a variable dependent on the apparent inductance.

In a further embodiment, the temporal voltage curve of the second voltage signal and a determined temporal coil current curve are included in the determination of the apparent inductance or the variable dependent on the apparent inductance,
wherein the temporal coil current curve describes the coil current during the temporal voltage curve.

In one embodiment, the second voltage signal has a time subinterval tᵣᵢₛₑ,
wherein an amount of the coil current rises within the time subinterval tᵣᵢₛₑ from an in particular defined first coil current value to an in particular defined second coil current value,
where the control function depends on a product of the duration of the time subinterval tᵣᵢₛₑ and a function dependent on the second voltage U_{hold,2}.

In one embodiment, the first voltage signal is applied, in particular once, to the device for generating the magnetic field when the magnetic-inductive flowmeter is started up.

The advantage of the embodiment is that the nominal width-dependent control setpoint value in the adjustment process no longer has to be determined manually for each device using an external measuring probe and subsequently stored in the magnetic-inductive flowmeter. Instead, the control setpoint value is determined using the function dependent on the first voltage U_{hold,1}, in particular the first voltage U_{hold,1}, and, according to one embodiment, also the regulated duration of the third time subinterval t_{shot,1}.

One embodiment provides the method step of:
determining a corrected coil current setpoint value as a function of a regulated coil current value determined during a measurement interval of the second voltage signal,
   wherein the second voltage signal replaces the first voltage signal for recalibrating the coil current setpoint value for the duration of a calibration interval,
   wherein the predetermined coil current setpoint value of the first voltage signal is replaced by the corrected coil current setpoint value of the second voltage signal.

Controlling the first voltage signal, in particular the first voltage U_{hold,1}, in such a way that a predetermined coil setpoint value is reached in a measurement interval has the disadvantage that this does not automatically ensure that the magnetic field produced by the device for generating the magnetic field also corresponds to the reference magnetic field produced during the adjustment process. By switching the first voltage signal to a second voltage signal, in which there is no control to a predetermined coil current, but the latter remains variable, it is possible to check whether the predetermined coil current setpoint is still valid. Alternatively, the coil current value now present in the second voltage signal, in particular in the measurement interval, can be adopted as the corrected coil current setpoint value. Once the coil current setpoint value has been determined during the duration of the second voltage signal, the first voltage signal is again applied to the device for generating the magnetic field.

In one embodiment, 1≤t_{hold}≤2000 ms, in particular 5≤t_{hold}≤1000 ms.

In one embodiment, 0.1≤tₛₕₒₜ≤500 ms, in particular 0.1≤t_{hold}≤300 ms.

In one embodiment, 1≤Uₛₕₒₜ≤230 V, in particular 3.6≤Uₛₕₒₜ≤60 V.

In one embodiment, 0.1≤U_{hold}≤23 V, in particular 0.5≤U_{hold}≤20 V.

In one embodiment, 5≤l≤2000 mA, in particular 10≤l≤500 mA.

In one embodiment, the control setpoint value assumes a value between 0.01 and 10 Wb.

In one embodiment, the first time subinterval follows the second time subinterval in the voltage curve.

In one embodiment, coil currents of different measurement intervals are changing variables or coil current values of different measurement intervals differ from each other.

One embodiment provides for the magnetic-inductive flowmeter to be designed as a magnetic-inductive flow measurement device, comprising a measuring tube for conducting the flowable medium.

One embodiment provides for the magnetic-inductive flowmeter to be designed as a magnetic-inductive flow measuring probe to be introduced into a lateral opening of a pipeline, comprising a housing to be supplied with the medium.

The invention is explained in greater detail with reference to the following figures. In the figures:

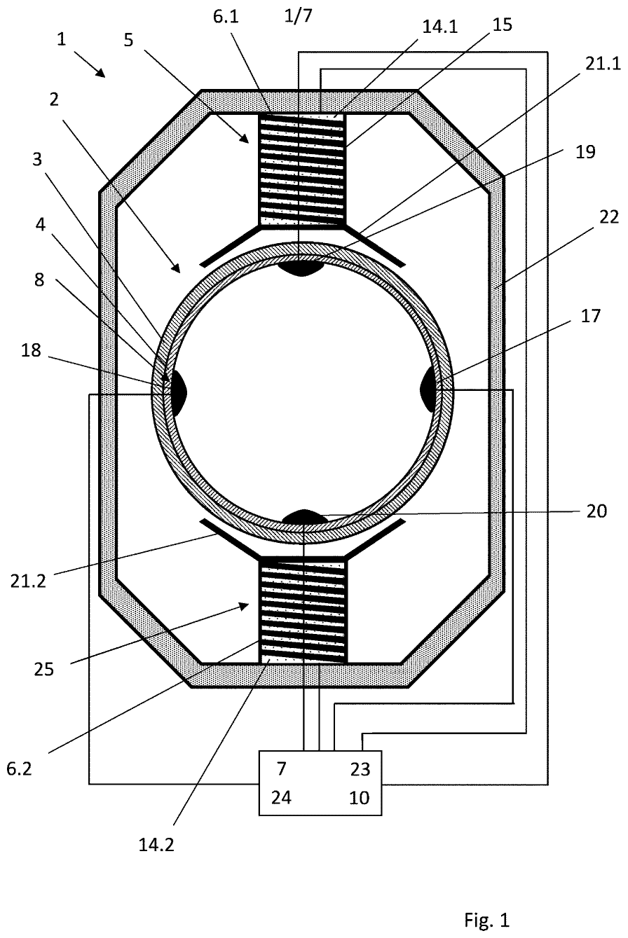

FIG. 1: shows an embodiment of a magnetic-inductive flowmeter according to the invention;

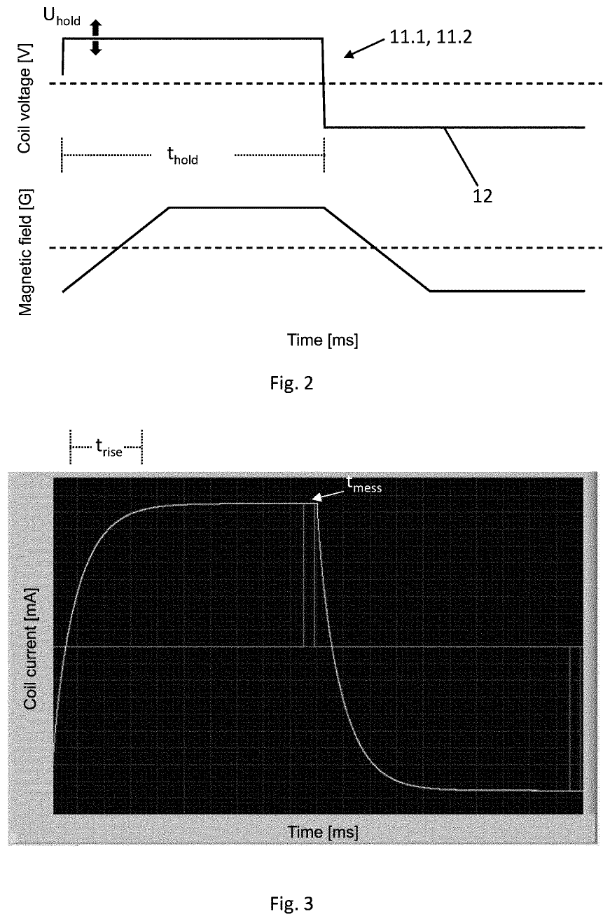

FIG. 2: shows a first embodiment of the first voltage signal and/or the second voltage signal and the correspondingly produced magnetic field through the coil arrangement;

FIG. 3: shows a first embodiment of the curve of the current flowing through the coil arrangement;

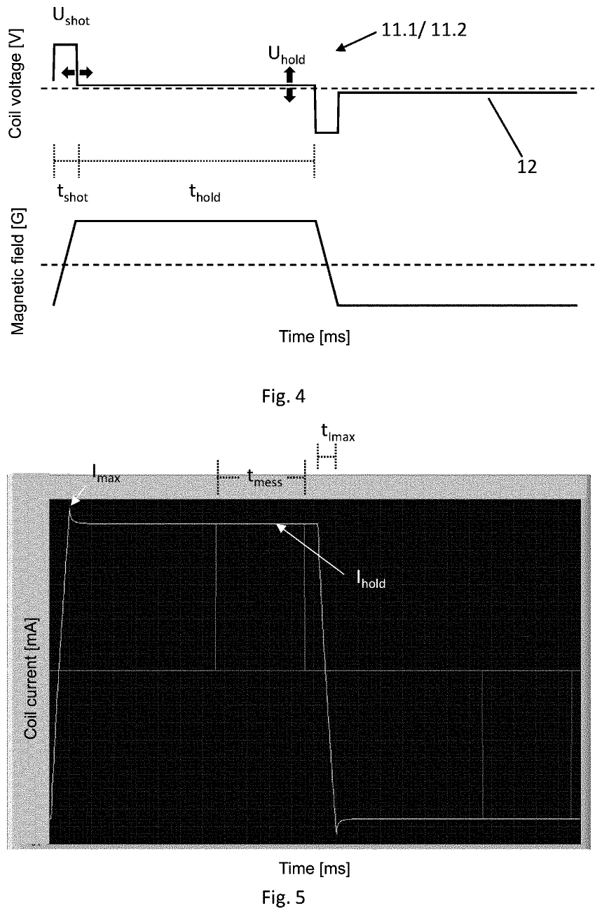

FIG. 4: shows a second embodiment of the first voltage signal and/or the second voltage signal and the correspondingly produced magnetic field through the coil arrangement;

FIG. 5: shows a second embodiment of the curve of the current flowing through the coil arrangement;

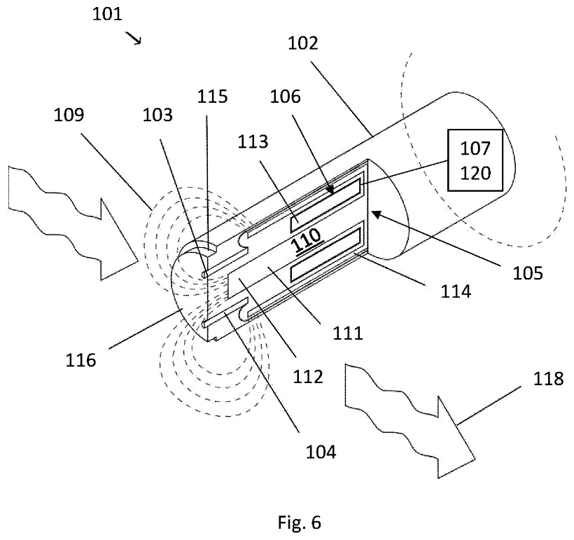

FIG. 6: shows a perspective view of a partially sectioned embodiment of a magnetic-inductive flow measuring probe according to the invention;

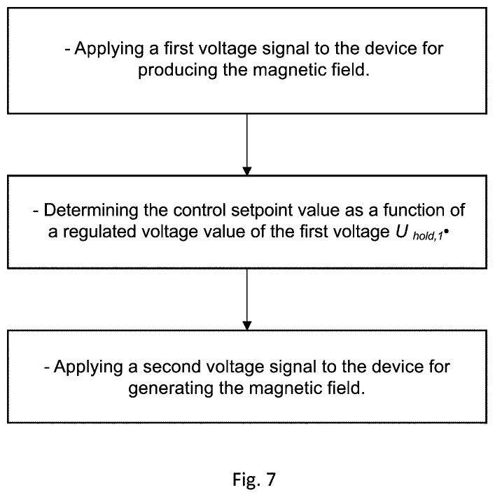

FIG. 7: shows a representation of an embodiment of the method sequence;

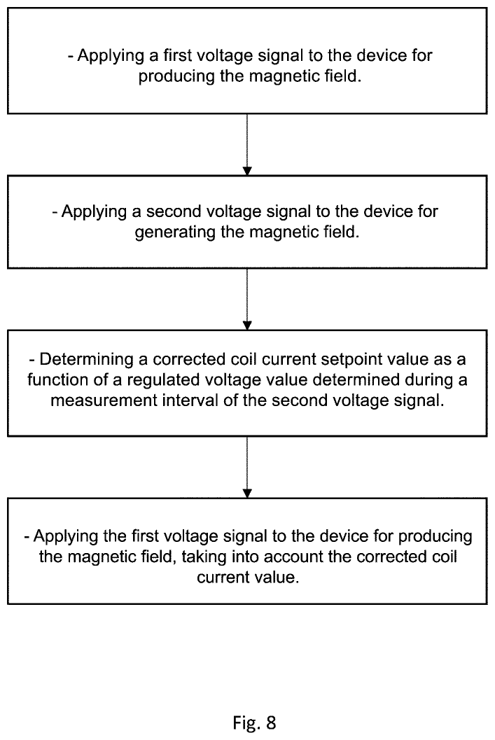

FIG. 8: shows a representation of a further embodiment of the method sequence;

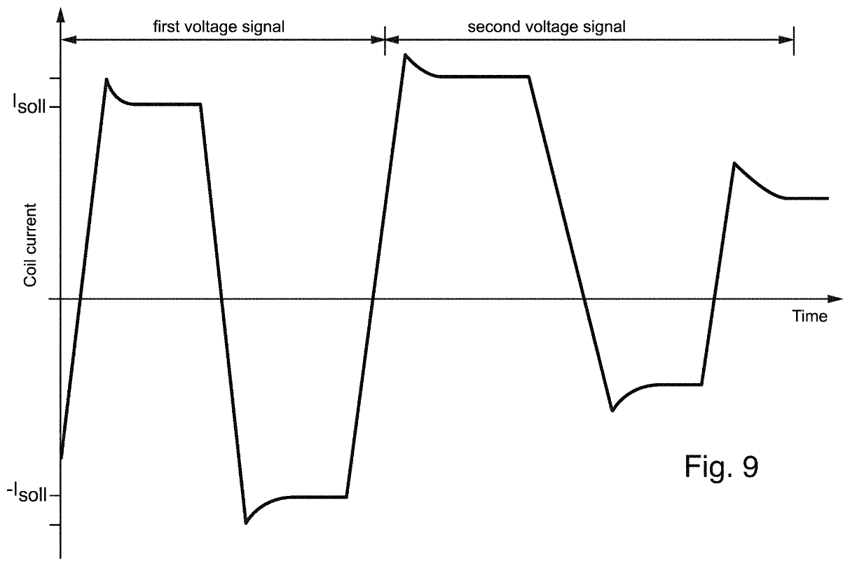

FIG. 9: shows a curve of the coil current resulting from an operating signal comprising the first voltage signal and the second voltage signal.

FIG. 1 shows a cross section of an embodiment of the magnetic-inductive flow measurement device 1 according to the invention. The structure and measuring principle of a magnetic-inductive flow measurement device 1 are known in principle. A flowable medium having an electrical conductivity is conducted through a measuring tube 2. The measuring tube 2 comprises a carrier tube 3, which is usually formed of, or at least comprises, steel, ceramic, plastic or glass the same. A device 5 for generating a magnetic field is arranged on the carrier tube 3 such that the magnetic field lines are oriented substantially perpendicularly to a longitudinal direction defined by the measuring tube axis. The device 5 for generating the magnetic field comprises a coil arrangement consisting of at least one saddle coil or at least one coil 6. Magnetic-inductive flowmeters usually have two diametrically arranged coils 6. A coil core 14 usually extends through a receptacle 15 of the coil 6. The receptacle 15 is understood to mean the volume limited by the coil wire forming the coil 6. The receptacle 15 of the coil 6 can thus be formed by a coil holder or by the imaginary enclosed volume. The latter occurs when the coil wire of the coil 6 is wound directly around the coil core 14. The coil core 14 is formed from a magnetically conductive, in particular soft magnetic material. The device 5 for generating the magnetic field usually also comprises a pole shoe 21 which is arranged at one end of the coil core 14. The pole shoe 21 can be a separate component or can be monolithically connected to the coil core 14. In the depicted embodiment of FIG. 1, two diametrically arranged coils 6.1, 6.2 each have a coil core 14.1, 14.2 and a pole shoe 21.1, 21.2. The two coil cores 14.1, 14.2 are connected to one another via a field return 22. The field return 22 connects the sides of the coil cores 14.1, 14.2 facing away from one another in each case. However, magnetic-inductive flow meters having exactly one coil having a coil core or a saddle coil and without a field return are also known. The device 5 for generating a magnetic field, in particular the coil 6, is connected to an operating circuit 7, which operates the coil 6 with a voltage signal 11. The voltage signal 11 can be a voltage with a time-variable voltage curve and is characterized by voltage signal parameters, wherein at least one of the voltage signal parameters is controllable. The magnetic field built up by the device 5 for generating the magnetic field is produced by a voltage of alternating polarity clocked by means of an operating circuit 7. This ensures a stable zero point and makes the measurement insensitive to influences due to electrochemical disturbances. The two coils 6.1, 6.2 can be connected separately to the operating circuit 7 or connected in series or parallel to one another.

When the magnetic field is applied, a flow-dependent potential distribution results in the measuring tube 2, which potential distribution can be detected, for example, in the form of an induced measurement voltage. A device 8 for tapping off the induced measurement voltage is arranged on the measuring tube 2. In the embodiment shown, the device 8 for tapping off the induced measurement voltage is formed by two oppositely arranged measurement electrodes 17, 18 to form a galvanic contact with the medium. However, what is also known are magnetic-inductive flow measurement devices which comprise measuring electrodes arranged on the outer wall of the carrier tube 3 which are not in contact with a medium. The measuring electrodes 17, 18 are generally arranged diametrically and form an electrode axis, or are intersected by a transverse axis which runs perpendicularly to the magnetic field lines and the longitudinal axis of the measuring tube 2. However, what is also known are devices 8 for tapping off the induced measurement voltage which have more than two measuring electrodes. The flow-rate-dependent measured variable can be determined on the basis of the measured measurement voltage. The flow-rate-dependent measured variable comprises the flow rate, the volume flow, and/or the mass flow of the medium. A measuring circuit 8 is configured to detect the induced measurement voltage applied to the measuring electrodes 17, 18, and an evaluation circuit 24 is designed to determine the flow-rate-dependent measured variable. Magnetic-inductive flow measurement devices having temperature sensors 26 are known. These can be arranged in an opening on the side or integrated in one of the electrodes.

The carrier tube 3 is often formed from an electrically conductive material such as steel. In order to prevent the measurement voltage applied to the first and second measuring electrodes 2, 3 from being conducted away via the carrier tube 3, the inner wall is lined with an insulating material, for example a (plastic) liner 4.

Commercially available magnetic-inductive flow measurement devices have two further electrodes 19, 20 in addition to measuring electrodes 17, 18. For one thing, a fill-level monitoring electrode 19 attached ideally at the highest point in the measuring tube 2 serves to detect partial filling of the measuring tube 1 and is configured to pass this information to the user and/or to take into account the fill level when determining the volume flow. Furthermore, a reference electrode 20, which is usually attached diametrically to the fill-level monitoring electrode 19 or at the lowest point of the measuring tube cross-section, serves to establish a controlled electric potential in the medium. Generally, the reference electrode 20 is used to connect the flowing medium to a ground potential.

The operating circuit 7, controller circuit 10, measuring circuit 23 and evaluation circuit 24 can be part of a single electronic circuit or can form individual circuits. At least the controller circuit 10 has a microprocessor, in particular a programmable microprocessor, i.e., a processor designed as an integrated circuit. Said microprocessor is configured to adjust the voltages and the duration of the time subintervals and to change them so that the specification for the control function is fulfilled. The operating circuit 7 is configured to apply a first coil voltage signal and a second coil voltage signal that differs from the first coil voltage signal. For this purpose, the controller circuit is configured to control the first voltage signal in such a way that the coil current assumes a coil current setpoint value in a measurement interval of the first voltage signal and to control the second voltage signal according to a criterion that differs therefrom.

The operating circuit 7 is configured to apply a first voltage to the device 5 for generating the magnetic field for a first time subinterval. According to an advantageous embodiment, the time intervals also each have a second time subinterval, in which a second voltage, which is in particular constant over the, in particular entire, second time subinterval, is applied to the device 5 for generating the magnetic field; a second voltage is also to be applied to the coil arrangement for a second time subinterval. The second voltage is greater than the first voltage. In addition, in a single time interval, the first time subinterval follows the second time subinterval. The duration of the first time subinterval is greater than the duration of the second time subinterval. The duration of the second time subinterval is a controllable variable. So is the first voltage. FIGS. 2 to 5 show possible embodiments of the voltage signal.

According to the invention, the controller circuit 10 is configured to control one of the voltage signal parameters of the voltage signal, in particular at least the first voltage (U_{hold}), in such a way that a difference between a control function and a predetermined control setpoint value, in particular comprising a variable proportional to a magnetic flux, is minimal. The control function can depend on a product of the duration of the second time subinterval and a function dependent on the first voltage. For this purpose, the first voltage and the duration of the second time subinterval are controlled such that a variable dependent on the first voltage and on the duration of the second time subinterval does not differ from the control setpoint value. In case of a difference, due to magnetic interference fields or temperature influences, the two control parameters are adjusted until the difference between the product and the control setpoint value is minimal again.

FIG. 2 shows a first embodiment of the first voltage signal and/or the second voltage signal and the correspondingly produced magnetic field through the coils. Additional numbering of the individual voltage signals, voltages and time subintervals has been omitted, as the illustrated embodiment can be applied to both voltage signals. According to the invention, the voltage signal comprises a voltage with a time-variable curve 12 which is divided into time intervals t. The sign of the applied voltage changes in successive time intervals t. The voltage signal shown in FIG. 2 comprises time intervals t, each having a time subinterval t_{hold} in which a constant voltage U_{hold} is applied to the coil over the entire duration of the first time subinterval t_{hold}. The detected measurement voltage induced for determining the flow-rate-dependent measured variable is determined in the time subinterval t_{hold}, in particular during a measurement interval. During the measurement interval, a coil current flows through the device for generating the magnetic field. Said coil current is not constantly controlled for the second voltage signal, i.e., an absolute value of a coil current flowing during the measurement interval is a changing variable in different time intervals t. According to one embodiment, the controller circuit is configured to control the second voltage U_{hold,1} of a time interval t in such a way that a difference between a control function and a predetermined control setpoint value, in particular comprising a variable proportional to a magnetic flux, is minimal. According to the invention, the second voltage U_{hold,1} is a time-variable and controllable variable. The rise in the coil current is characterized by a duration of a time subinterval tᵣᵢₛₑ which can be determined via a measuring circuit. An absolute value of the current rises from a first coil current setpoint value to a second coil current setpoint value within the time subinterval tᵣᵢₛₑ. The second voltage U_{hold,1} is controlled in such a way that a variable dependent on the product of the duration of the time subinterval tᵣᵢₛₑ and the first voltage U_{hold,1} does not differ from a predetermined second setpoint value. The first voltage U_{hold,1} is designed in such a way that the coil current always assumes a predefined coil current setpoint value. The coil current setpoint value is constant for the entire first voltage signal, but can be replaced by a corrected coil current setpoint value.

FIG. 3 shows a time curve of the current resulting from the voltage signal in FIG. 2. After switching the applied voltage, the direction of the current changes. Within a rise time subinterval tᵣᵢₛₑ, the absolute value of the current rises with a non-linear behavior. The current approaches a maximum coil current value Iₘₐₓ. When the coil current is maximal and substantially no longer changes, the measurement interval tₘₑₐₛ begins. Only measurement voltages that are determined in this time interval are included in the determination of the flow-rate-dependent variable. For the first voltage signal, the maximum coil current value Iₘₐₓ corresponds to the coil current setpoint value. For the second voltage signal, the maximum coil current value Iₘₐₓ is a changing variable.

FIG. 4 shows a second embodiment of the first voltage signal and/or the second voltage signal and the produced magnetic field through the device for generating the magnetic field. The numbering has also been omitted here. According to the invention, the voltage signal comprises a voltage with a time-variable curve 12 which is divided into time intervals t. The sign of the applied voltage changes in successive time intervals t. The voltage signal shown in FIG. 4 comprises time intervals t, each having a time subinterval t_{hold} in which a constant voltage U_{hold} is applied to the coil over the entire duration of the first time subinterval t_{hold}. The detected measurement voltage induced for determining the flow-rate-dependent measured variable is determined in the time subinterval t_{hold}. In addition, the time intervals t each have a time subinterval tₛₕₒₜ in which a voltage Uₛₕₒₜ, which is in particular constant over the entire duration of the time subinterval tₛₕₒₜ is applied to the coil. The voltage Uₛₕₒₜ is greater than the voltage U_{hold}. In the voltage curve, the time subinterval t_{hold} follows the time subinterval tₛₕₒₜ. In addition, the duration of the time subinterval tₛₕₒₜ is shorter than the duration of the time subinterval t_{hold}. The duration of the time subinterval tₛₕₒₜ is time-variable and controllable. The same applies to the voltage U_{hold}. For the second voltage signal, at least the second voltage U_{hold,2} is controlled in such a way that a difference between a control function and a predetermined control setpoint value, in particular comprising a variable proportional to a magnetic flux, is minimal. The control function depends on a product of the duration of the fourth time subinterval t_{shot,2} and a function dependent on the second voltage U_{hold,2}. The control setpoint value can be predetermined for the entire voltage curve and therefore for all time intervals. Alternatively, time intervals with a positive sign in the voltage curve can have a first control setpoint value and time intervals with a negative sign can have a second control setpoint value, wherein the first control setpoint value differs from the second control setpoint value. For the first voltage signal, at least the first voltage U_{hold,1} is controlled in such a way that the coil current assumes the coil current setpoint value in the measurement interval, or that the difference between the coil current and the coil current setpoint value is minimal.

The voltage U_{hold} and the voltage Uₛₕₒₜ can be set such that a ratio between the voltage U_{hold} and the voltage Uₛₕₒₜ is constant over the entire voltage curve 12 or an absolute value of a quotient of the first voltage U_{hold} and the voltage Uₛₕₒₜ is constant over the voltage curve 12. This means that when controlling the first voltage U_{hold}, the voltage Uₛₕₒₜ is also automatically adjusted proportional to change. In this case, the function dependent on the voltage U_{hold} is preferably inversely proportional to the duration of the time subinterval tₛₕₒₜ. Alternatively, the voltage Uₛₕₒₜ or an absolute value of the voltage Uₛₕₒₜ can assume a constant value over the entire voltage curve 12.

In addition to controlling the voltage U_{hold}, the duration of the time subinterval tₛₕₒₜ is controlled in such a way that a determined value of a variable dependent on a test variable assumes a test setpoint value within the duration of the time subinterval tₛₕₒₜ.

An example of such an implementation is disclosed in WO 2014/001026 A1. The variable can be, for example, a coil current setpoint value, a sum or an integral of the measured values of the test variable for a predefined time segment. In this case, for the second voltage signal, the two control parameters are controlled in such a way that a function dependent on the product of the second voltage U_{hold,2} and the duration of the fourth time subinterval t_{shot,2} does not differ from a predetermined second control setpoint value. The function dependent on the second voltage U_{hold2} is inversely proportional to the duration of the fourth time subinterval t_{shot,2}. The test variable May be a measured value of the current, a time curve of a current, and/or a variable dependent thereon.

The controller circuit is configured to, if a coil test current value or a test variable dependent on the coil test current value differs from a setpoint value in a time interval t_{N}, change the duration of the second time subinterval tₛₕₒₜ such that the difference is smaller in a temporally subsequent time interval t_{N+M}, wherein M≥1. The controller circuit is also configured to, if the actual value differs from a setpoint value in a time interval t_{N}, change the first voltage U_{hold} such that the difference between a setpoint value is smaller in a temporally subsequent time interval t_{N+M}, wherein M≥1. However, at least one of the conditions listed above must be met. The controller circuit can be configured to control further variables and/or functions.

The control function, in particular the function dependent on the voltage U_{hold}, can also depend on ln((U_{shot,2}+U_{hold,2})/(U_{shot,2}−U_{hold,2})) or be proportional thereto.

FIG. 5 shows a time curve of the current through the device for generating the magnetic field, in particular through the coil arrangement, resulting from the voltage signal in FIG. 4. The coil current changes the direction of flow in the individual time intervals. By applying the second coil voltage, which is many times higher than the first voltage, the coil current increases rapidly. From the beginning of the first time subinterval, the coil current continues to increase until it reaches the maximum coil current value Iₘₐₓ. In this time subinterval, the eddy currents are substantially constant. The coil current then decreases and converges towards a substantially constant coil current value I_{hold}.

According to a further embodiment, a measuring circuit is configured to determine, in the second time subinterval t_{hold,2}, a maximum coil current value Iₘₐₓ, and the duration of the fourth time subinterval t_{shot,2} and the function dependent on the second voltage U_{hold,2} are controlled such that a control function does not differ from a predetermined second setpoint value, wherein the control function depends on a product of the duration of the fourth time subinterval t_{shot,2} and the function dependent on the second voltage U_{hold,2} and the maximum coil current value Iₘₐₓ.

Alternatively, the controller circuit can be configured to control at least one of the voltage signal parameters—preferably the second voltage U_{hold,2}—in such a way that one of a quotient of the maximum coil current value Iₘₐₓ and a coil current value I_{hold} determined during the second time subinterval t_{hold,2} is constant over the voltage signal.

According to one embodiment, the control function can depend on a product of the duration of a third time subinterval t_{Imax} and a function dependent on the second voltage U_{hold,2}. The third time subinterval t_{Imax} is limited by the start of the fourth time subinterval t_{shot,2} and a point in time at which the coil current assumes the maximum coil current value Iₘₐₓ.

The two curves shown in FIG. 2 to FIG. 5 are highly simplified schemes. The magnetic field settles generally after the second time subinterval.

The measuring principle on which the invention is based is first explained on the basis of the perspective and partially sectional illustration of FIG. 6. A flow measuring probe 101 comprises a generally circular cylindrical housing 102 having a predefined outer diameter. Said housing is adapted to the diameter of a bore, which is located in a wall of a tube line (not shown in FIG. 6) into which the flow measuring probe 101 is inserted in a fluid-tight manner. A medium to be measured flows in the pipeline, and the flow measuring probe 101 is immersed into said medium practically perpendicularly to the flow direction of the medium, which is indicated by the wavy arrows 118. A front end 116 of the housing 102 that projects into the medium is sealed in a fluid-tight manner with a front body 115 made of insulating material. By means of a coil arrangement 106 arranged in the housing 102, a magnetic field 109 that extends through the end portion into the medium can be produced. A coil core 111, which at least partially consists of a soft magnetic material and is arranged in the housing 102, terminates at or near the end portion 116. A field return body 114 which surrounds the coil arrangement 106 and the coil core 111 is configured to return, into the housing 102, the magnetic field 109 extending through from the end portion. The coil core 111, the pole shoe 112 and the field return body 114 are each field-conducting bodies 110, which together form a field-conducting arrangement 105. First and a second measuring electrodes 103, 104 forming a galvanic contact with the medium to be conducted form the device for detecting a measurement voltage induced in the medium and are arranged in the front body 115 and, like the outer walls of the housing, touch the medium. An electrical voltage induced due to Faraday's law of induction can be tapped off at the measuring electrodes 103, 104 by means of a measurement and/or evaluation unit. This is at a maximum if the flow measuring probe 101 is installed in the pipeline such that a plane spanned by a straight line intersecting the two measuring electrodes 103, 104 and by a longitudinal axis of the flow measuring probe runs perpendicularly to the flow direction 118 or to the longitudinal axis of the tube line. An operating circuit 107 is electrically connected to the coil arrangement 106, in particular to the coil 113, and is configured to impress a clocked voltage signal to the coil 113 in order to thus produce a clocked magnetic field 109. The controller circuit 120 is configured to execute the controls according to the invention.

FIG. 7 is a representation of an embodiment of the method sequence according to the invention. The method comprises the following method steps:
applying a first voltage signal to the device for generating the magnetic field.

In this case, the first voltage signal can be designed as in FIG. 2 or FIG. 4. However, it is controlled to a predetermined coil current setpoint value, particularly at the factory.
determining a control setpoint value, in particular comprising a variable proportional to the magnetic flux, as a function of a regulated voltage value of the first voltage U_{hold,1}.

Alternatively, the duration of the first time subinterval t_{hold,1} can also be used to determine the control setpoint value. An alternative to this would be to determine the control setpoint value as a function of a determined apparent self-inductance of the magnetic-inductive flowmeter, or a variable dependent thereon, and a coil current value of the measurement interval. The apparent self-inductance results from the self-inductance of the device for generating the magnetic field, the eddy currents in the, for example, metal carrier tube or housing, and any external device for generating an interference magnetic field.
applying a second voltage signal to the device for generating the magnetic field.

The second voltage signal can be designed as in FIG. 2 or FIG. 4. However, it is controlled to a specified control setpoint value with a value proportional to a magnetic flux.

FIG. 8 is a representation of an embodiment of the method sequence according to the invention. The method comprises the following method steps:
applying a first voltage signal (11.1) to the device (5) for generating the magnetic field.

In this case, the first voltage signal can be designed as in FIG. 2 or FIG. 4. However, it is controlled to a predetermined coil current setpoint value, particularly at the factory.
applying a second voltage signal (11.2) to the device (5) for generating the magnetic field.

The second voltage signal can be designed as in FIG. 2 or FIG. 4. However, it is controlled to a specified control setpoint value with a value proportional to a magnetic flux.
determining a corrected coil current setpoint value as a function of a regulated coil current value determined during a measurement interval of the second voltage signal.

The second voltage signal replaces the first voltage signal for recalibrating the coil current setpoint value for the duration of a calibration interval. The coil current value, which is regulated during the measurement interval of the second voltage signal but is variable, is adopted as the corrected coil current setpoint value.
applying the first voltage signal to the device for generating the magnetic field.

In this case, the first voltage signal is controlled with the corrected coil current setpoint value.

FIG. 9 shows an example of a time curve of the coil current which results from an operating signal comprising the first voltage signal and the second voltage signal and flows through the device for generating the magnetic field. In the first region of the curve, the first voltage signal is applied to the device for generating the magnetic field. The first voltage is always controlled in such a way that the difference between the coil current and the coil current setpoint value Iₛₑₜ is always minimal in the measurement interval. This means that the absolute value of the coil current in the measurement interval always substantially assumes a coil current setpoint value Iₛₑₜ. In the second region, the second voltage signal is applied to the device for generating the magnetic field. The coil current no longer has a predetermined coil current setpoint value Iₛₑₜ and is therefore a changing variable. This therefore results in a lower coil current value compared to the coil current setpoint value Iₛₑₜ or a higher coil current value during the measurement intervals, for example due to an external permanent magnet. The second voltage signal is applied during a calibration interval of the first voltage signal. Alternatively, the first voltage signal can again be applied to the device for generating the magnetic field in a third region (not shown).

1-19. (canceled)

20. A method for operating a magnetic-inductive flowmeter for determining a flow rate-dependent measured variable of a flowable medium, wherein the magnetic-inductive flowmeter comprises a device for generating a magnetic field and a device for tapping a measurement voltage in the medium, the method comprising:
applying a first voltage signal to the device for generating the magnetic field, wherein the first voltage signal defines a first voltage curve, which is variable over time and which is divided into first time intervals, wherein:
the first time intervals each have a first time subinterval, in which a first voltage, which is constant over the entire first time subinterval, is applied to the device for generating the magnetic field;
the first time intervals each have at least one measurement interval in which a coil current flows through the device for generating the magnetic field;
the first voltage is controlled such that a difference between the coil current and a predetermined coil current setpoint value is minimized during the measurement interval; and
the coil current setpoint value is constant for the entire first voltage signal; and
applying a second voltage signal to the device for generating the magnetic field, wherein the second voltage signal defines a second voltage curve, which is variable over time and which is divided into second time intervals,
wherein the second time intervals each have a second time subinterval, in which a second voltage, which is constant over the entire second time subinterval, is applied to the device for generating the magnetic field, and
wherein the second voltage is controlled such that a difference between a control function and a control setpoint value, which includes a variable proportional to a magnetic flux, is minimized.

21. The method according to claim 20, further comprising:
determining the control setpoint value as a function of a regulated voltage value of the first voltage.

22. The method according to claim 20, wherein:
the first time intervals of the first voltage signal each have a third time subinterval, in which a third voltage, which is constant over the entire third time subinterval, is applied to the device for generating the magnetic field;
the third voltage is greater than the first voltage;
a duration of the third time subinterval is a controllable variable; and
a regulated duration of the third time subinterval is included in the determination of the control setpoint value.

23. The method according to claim 20, wherein:
the second time intervals of the second voltage signal each have a fourth time subinterval, in which a fourth voltage, which is constant over the fourth time subinterval, is applied to the device for generating the magnetic field;
the fourth voltage is greater than the second voltage; and
the control function depends on a product of a duration of the fourth time subinterval and a function dependent on the second voltage.

24. The method according to claim 23, wherein a quotient of the second voltage and the fourth voltage is constant over the second voltage curve,
wherein the function dependent on the second voltage is inversely proportional to the duration of the fourth time subinterval.

25. The method according to claim 23, wherein a value of the fourth voltage is constant over the time intervals.

26. The method according to claim 22, wherein a value of a quotient of the first voltage and the third voltage is constant over the first voltage curve.

27. The method according to claim 22, wherein a value of the third voltage is constant over the time intervals.

28. The method according to claim 23, wherein the coil current assumes a maximum coil current value in each of the time intervals of the second voltage signal in the second time subinterval,
wherein a condition is satisfied that a parameter, which depends on a quotient of the maximum coil current value and a coil current value determined during the measurement interval, is constant over the second voltage signal.

29. The method according to claim 23, wherein the coil current in each case assumes a maximum coil current value in the second time subinterval of the second voltage signal, and
wherein the function dependent on the second voltage also depends on the maximum coil current value.

30. The method according to claim 23, wherein the function dependent on the second voltage also depends on:
$$ln ( ( {U}_{shot , 2} + {U}_{hold , 2} ) / ( {U}_{shot , 2} - {U}_{hold , 2} ) )$$
and is proportional thereto,
wherein U_{shot,2} is the fourth voltage, and U_{hold,2} is the second voltage.

31. The method according to claim 22, wherein the control setpoint value is also determined as a function of the third voltage.

32. The method according to claim 20, wherein the coil current in each case assumes a maximum coil current value in the second time subinterval of the second voltage signal,
wherein the control setpoint value is also determined as a function of the maximum coil current value and/or a coil current value determined during the measurement interval of the second voltage signal.

33. The method according to claim 20, wherein the control setpoint value is determined as a function of an apparent inductance or a variable dependent on the apparent inductance.

34. The method according to claim 33, wherein a temporal voltage curve of the second voltage signal and a determined temporal coil current curve are included in the determination of the apparent inductance or the variable dependent on the apparent inductance,
wherein the temporal coil current curve describes the coil current during the temporal voltage curve.

35. The method according to claim 20, wherein the second voltage signal has another time subinterval,
wherein a value of the coil current rises within the other time subinterval from a defined first coil current value to a defined second coil current value, and
wherein the control function depends on a product of the duration of the other time subinterval and a function dependent on the second voltage.

36. The method according to claim 20, wherein the first voltage signal is applied, in particular once, to the device for generating the magnetic field when the magnetic-inductive flowmeter is started up.

37. The method according to claim 20 further comprising:
determining a corrected coil current setpoint value as a function of a regulated coil current value determined during a measurement interval of the second voltage signal,
wherein the second voltage signal replaces the first voltage signal for recalibrating the coil current setpoint value for the duration of a calibration interval, and
wherein the predetermined coil current setpoint value of the first voltage signal is replaced by the corrected coil current setpoint value of the second voltage signal.

38. A magnetic-inductive flowmeter for determining a flow rate-dependent measured variable for a flowable medium, the magnetic-inductive flowmeter comprising:
a device for generating a magnetic field;
a device for tapping a measurement voltage in the medium; and
an operating circuit is configured to perform the method according to claim 20.
